(19) United States
(12) Patent Application Publication
(10) Pub. No.: US 2024/0223727 A1
(43) Pub. Date: Jul. 4, 2024

(54) USER TRANSPARENCY FOR VIDEO CONFERENCING

(71) Applicant: META PLATFORMS, INC., Menlo Park, CA (US)

(72) Inventors: Anshul Kumar Jain, Sunnyvale, CA (US); Jian Zhang, Sunnyvale, CA (US); Zacharie Sciamma, Sunnyvale, CA (US); Brynn Chernosky, New York, NY (US)

(21) Appl. No.: 18/465,834

(22) Filed: Sep. 12, 2023

Related U.S. Application Data
(60) Provisional application No. 63/478,387, filed on Jan. 4, 2023.

(51) Int. Cl. H04N 7/15; G06T 7/194; G06T 7/50; G06V 10/25; H04N 5/272

(52) U.S. Cl. CPC H04N 7/152; G06T 7/194; G06T 7/50; G06V 10/25; H04N 5/272; G06V 2201/07

(57) ABSTRACT

A solution for managing a video conference is provided. Multiple segmentation areas or shapes are stored and made transparent. The background is recorded continuously and simultaneously in a memory presented to a user for a second participant when they are participating in a video conference with a first participant. The segmentation or transparency of objects obstructing information in view of the video conference is selected based on attributes of the first or second participant, or attributes of the video conference. The segmentation may be utilized to provide a desired view, message, or information to individuals participating in, watching, or interacting with a first participant via video conferencing. The background includes static images, a live video feed, a recorded video feed, a static webpage, a non-static webpage, on any surface without obstruction when a first participant is in front of the surface sharing information due to segmentation/transparency of the first participant.

### CROSS-REFERENCE TO RELATED APPLICATIONS

This application claims the benefit of U.S. Provisional Application No. 63/478,387 filed Jan. 4, 2023, the entire content of which is incorporated herein by reference.

### TECHNOLOGICAL FIELD

The examples of this disclosure relate generally to video conferencing, and more particularly, to managing the view of a background during video conferencing.

### BACKGROUND

The use of video conferencing is ever expanding, particularly in light of the trend for corporate employees working in hybrid arrangements. Hybrid work arrangements may include an employee working at a mobile work location away from a traditional office. However, when an employee is located in a non-traditional work location, such as a home office, vacation location, etc., it may be difficult for a viewer to see information shared in the background of the video feed. For example, a presenter is writing notes on a surface within the view or background of a video conference, the presenter may become an obstruction to the information shared during the video conference. The same obstruction may be seen for those individuals in the same room as the presenter, which may become distracting and slow down the flow of team meetings. Obstruction of written information may be a disruption to seamless collaboration via video conferencing.

A conventional approach to address this issue is to use a specialized surface that is connected to the video conferencing platform to capture written information to viewers. This conventional approach may be costly as a new surface would need to be purchased and installed for proper use.

In view of the foregoing drawbacks, it may be beneficial to provide a video conferencing system to facilitate collaboration that may be cost efficient and allow for seamless transmission of written information in the view of the camera.

### BRIEF SUMMARY

Methods and systems for video conferencing via a video conferencing system are disclosed. The video conferencing system disclosed may allow for seamless sharing of information between individuals in separate environments.

In an example the video conferencing system may include a method of managing video conferencing, the method comprising: configuring display of a first participant to a second participant of the video conference using a computer system, the configuring including: selecting a segmentation area for the first participant from based on a first participant identification or a second participant identification; applying a set of segmentation rules in response to the first participant identification or the second participant identification using the computer system, wherein the first participant is presenting information to the second participant; and providing a background from the computer system for display to the second participant in conjunction with isolated segmentation data corresponding to the first participant isolated from the background of the first participant during the video conference.

In an example the video conferencing system may provide a computer system comprising: a set of computing devices configured to manage a video conferencing by performing a method configuring display of a first participant to a second participant of the video conference, the configuring including: selecting a segmentation area for the first participant based on the first participant identification or the second participant identification using the computer system; applying via computer system a set of segmentation rules in response to the first participant identification or the second participant identification, wherein the first participant is presenting information to the second participant; and providing a background from the computer system for display to the second participant in conjunction with isolated segmentation data corresponding to the first participant isolated from the background of the first participant during the video conference.

Additional features and advantages will be set forth in the detailed description Still other objects of the present disclosure will become readily apparent to those skilled in the art from that description, simply by way of illustration of the best modes suited to carry out the invention. It is to be understood that both the foregoing description and the following detailed description are merely exemplary and are intended to provide an overview or framework to understand the nature and character of the claims. The invention described herein, is capable of other different examples and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates a schematic block diagram of an exemplary system.

FIG. 2 illustrates a block diagram of an exemplary communication device.

FIG. 3 illustrates a computing device for video conference management according to an example.

FIG. 4 illustrates image data captured by a camera for a presenter of a video conference.

FIG. 5 illustrates image data including isolated transparent presenter image data according to an example.

FIG. 6 illustrates a machine learning and training model according to an example.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout.

As defined herein a “computer-readable storage medium,” which refers to a non-transitory, physical, or tangible storage medium (e.g., volatile, or non-volatile memory device), may be differentiated from a “computer-readable transmission medium,” which refers to an electromagnetic signal.

As defined herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

It is to be understood that the methods and systems described herein are not limited to specific methods, specific components, or to particular implementations. It is also to be understood that the terminology used herein is for the purpose of describing particular examples only and is not intended to be limiting.

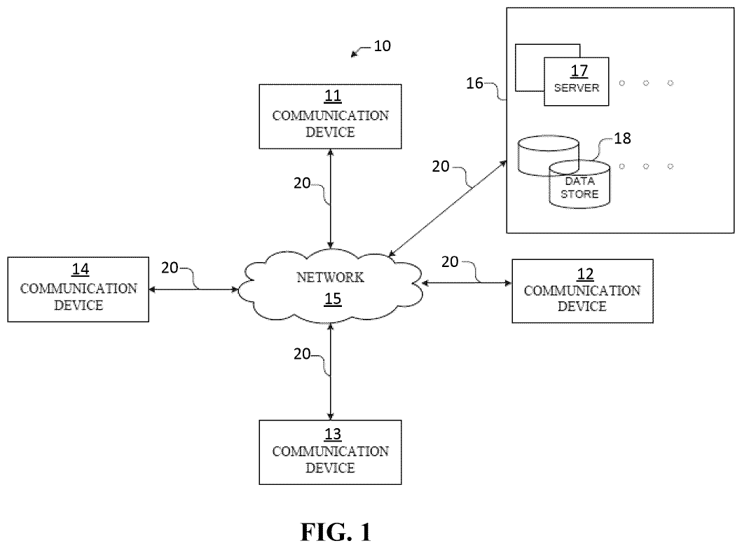

Reference is now made to FIG. 1, which is a block diagram of a system according to an example. As shown in FIG. 1, the system 10 may include one or more communication devices 11, 12, 13 and 14 and a network device 16. Additionally, the system 10 may include any suitable network such as, for example, network 15. As an example and not by way of limitation, one or more portions of network 15 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 15 may include one or more networks 15.

Links 20 may connect the communication devices 11, 12, 13 and 14 to network 15, network device 16 and/or to each other. This disclosure contemplates any suitable links 20. In some examples, one or more links 20 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary examples, one or more links 20 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 20, or a combination of two or more such links 20. Links 20 need not necessarily be the same throughout system 10. One or more first links 20 may differ in one or more respects from one or more second links 20.

In some examples, communication devices 11, 12, 13, and 14 may be electronic devices including hardware, software, or embedded logic components or a combination of two or more such components and capable of carrying out the appropriate functionalities implemented or supported by the communication devices 11, 12, 13, and 14. As an example, and not by way of limitation, the communication devices 11, 12, 13, and 14 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 11, 12, 13, and 14 may enable one or more users to access network 15. The communication devices 11, 12, 13, and 14 may enable a user(s) to communicate with other users at other communication devices 11, 12, 13, and 14.

Network device 16 may be accessed by the other components of system 10 either directly or via network 15. As an example, and not by way of limitation, communication devices 11, 12, 13, and 14 may access network device 16 using a web browser or a native application associated with network device 16 (e.g., a mobile social-networking application, a messaging application, another suitable application, or any combination thereof) either directly or via network 15. In particular examples, network device 16 may include one or more servers 17. Each server 17 may be a unitary server or a distributed server spanning multiple computers or multiple datacenters. Servers 17 may be of various types, such as, for example and without limitation, web server, news server, mail server, message server, advertising server, file server, application server, exchange server, database server, proxy server, another server suitable for performing functions or processes described herein, or any combination thereof. In particular examples, each server 17 may include hardware, software, or embedded logic components or a combination of two or more such components for carrying out the appropriate functionalities implemented and/or supported by server 17. In particular examples, network device 16 may include one or more data stores 18. Data stores 18 may be used to store various types of information. In particular examples, the information stored in data stores 18 may be organized according to specific data structures. In particular examples, each data store 18 may be a relational, columnar, correlation, or other suitable database. Although this disclosure describes or illustrates particular types of databases, this disclosure contemplates any suitable types of databases. Particular examples may provide interfaces that enable communication devices 11, 12, 13, and 14 and/or another system (e.g., a third-party system) to manage, retrieve, modify, add, or delete, the information stored in data store 18.

Network device 16 may provide users of the system 10 the ability to communicate and interact with other users. In particular examples, network device 16 may provide users with the ability to take actions on various types of items or objects, supported by network device 16. In particular examples, network device 16 may be capable of linking a variety of entities. As an example, and not by way of limitation, network device 16 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 16 and four communication devices 11, 12, 13 and 14 any suitable number of network devices 15 and communication devices 11, 12, 13 and 14 may be part of the system of FIG. 1 without departing from the spirit and scope of the present disclosure.

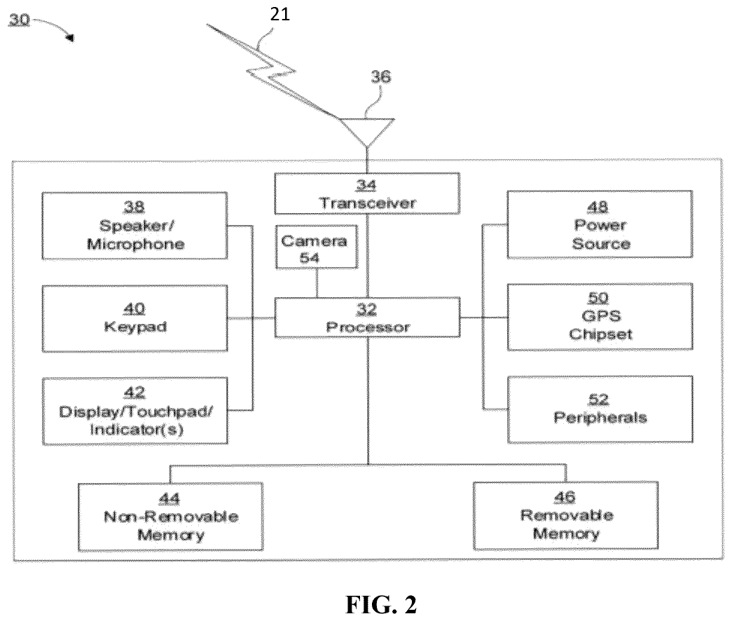

FIG. 2 illustrates a block diagram of an exemplary hardware/software architecture of a communication device such as, for example, user equipment (UE) 30. In some examples, the UE 30 may be any of communication devices 11, 12, 13, and 14. In some examples, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an example, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an example.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removeable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment (e.g., via network 21). For example, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In another example, the transmit/receive element 36 may be configured to transmit and/or receive both RF and light signals. It will be appreciated that the transmit/receive element 36 may be configured to transmit and/or receive any combination of wireless or wired signals. In yet another example, transmit/receive element 36 be used to connect communication device (e.g., communication device 11, 12, 13, and 14) to an external communications network, such as network 21 to enable communication device 11, 12, 13, and 14 to communicate with other nodes (e.g., UE 30) of the network.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other examples, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an example.

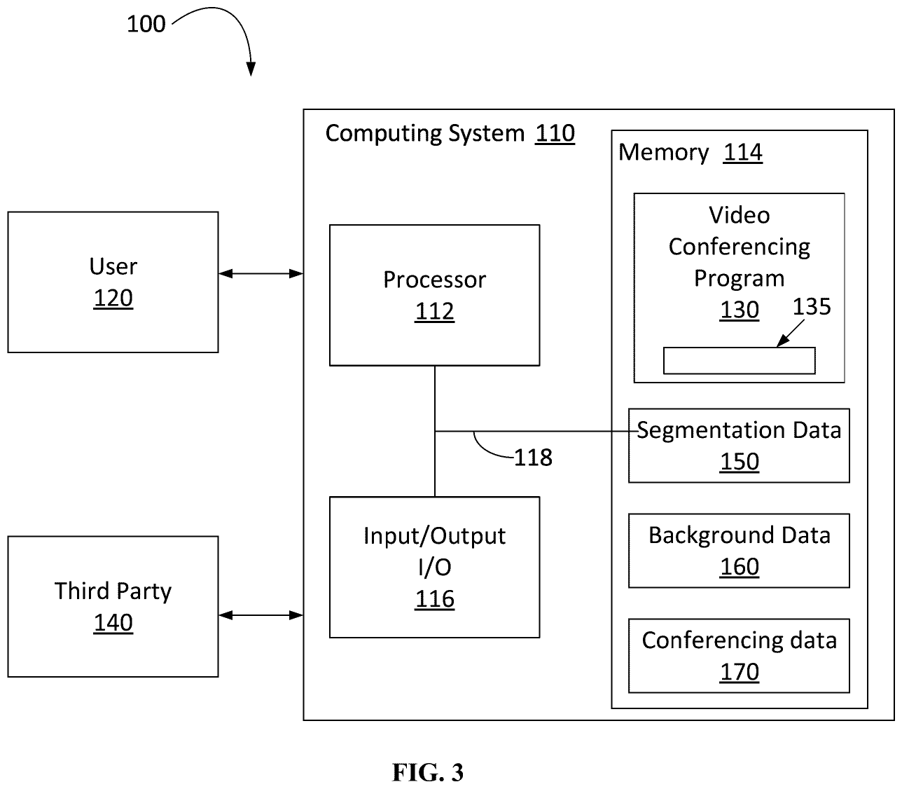

FIG. 3 illustrates hardware or software architecture such as, for example, system architecture 100 for video conference management according to an example. System architecture 100 includes a computing system 110 configured to perform a process described herein to manage a video conference between a user 120 and one or more third parties 140. Computing system 110 may also be used to implement components of the computing system 110 or be part of the UE 30. The computing system 110 may comprise a computer or server and may be controlled primarily by computer readable instructions, which may be in the form of software, wherever, or by whatever means such software is stored or accessed. Such computer readable instructions may be executed within a processor (i.e., processor 112). Computing system 110 may comprise a video conferencing program 130, which makes computing system 110 operable to manage a video conference by performing a process described herein. User 120 and third party 140 may refer to a computing device being used by a user or to an individual interacting with system architecture 100.

Computing system 110 is shown including a processor 112 (e.g., one or more processors), a memory 114 (e.g., a storage hierarchy), an input/output (I/O) 116 (e.g., one or more I/O interfaces and/or devices), and a communications pathway 118. In general, the processor 112 executes program code, such as video conferencing program 130, which is at least partially fixed in memory 114. While executing program code, the processor 112 may process data, which may result in reading and/or writing transformed data from/to memory 114 or I/O 116 for further processing. Communications pathway 118 provides a communications link between each of the components in computing system 110. I/O 116 may comprise one or more I/O devices, which enable a user 120 to interact with computing system 110 and/or one or more communications devices to enable user 120 to communicate with computing system 110 using any type of communications link. To this extent, video conferencing program 130 may manage a set of interfaces (e.g., graphical user interface(s), application program interface, and/or the like) that enable human and/or system users 120 to interact with video conferencing program 130. Further, video conferencing program 130 may manage (e.g., store, retrieve, create, manipulate, organize, present, etc.) the data, such as segmentation data 150, background data 160, and conferencing data 170.

Computing system 110 may comprise one or more general purpose computing articles of manufacture (e.g., computing devices) capable of executing program code, such as video conferencing program 130, installed thereon. It is to be understood that “program code” means any collection of instructions, in any language, code or notation, that cause a computing device having an information processing capability to perform a particular action either directly or after any combination of the following: conversion to another language, code or notation; reproduction in a different material form; or decompression. To this extent, video conferencing program 130 may be any combination of system software or application.

Further, video conferencing program 130 may be implemented using a set of modules 132. In this case, a module 132 may enable computing system 110 to perform a set of tasks used by video conferencing program 130 and may be separately developed or implemented apart from other portions of video conferencing program 130. As referred to herein the term “component” means any configuration of hardware, with or without software, which implements the functionality described in conjunction therewith using any solution, while the term “module” means program code that enables a computing system 110 to implement the actions described in conjunction therewith using any solution. When fixed in a memory 114 of a computing system 110 that includes a processor 112, a module may be a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computing system 110.

When computing system 110 comprises multiple computing devices, each computing device may have only a portion of video conferencing program 130 fixed thereon (e.g., one or more modules 132). It is to be understood that computing system 110 and video conferencing program 130 are only representative of various possible computer systems that may perform a process described herein. In some examples, the functionality provided by computing system 110 and video conferencing program 130 may be at least partially implemented by one or more computing devices that include any combination of general and/or specific purpose hardware with or without program code.

Regardless, when computing system 110 includes multiple computing devices, the computing devices may communicate over any type of communications link (e.g., a network 21, a local area network (LAN), internet, network 15 etc.). Further, while performing a process, computing system 110 may communicate with one or more other computer systems, such as user 120 or third party 140, using any type of communications link. In either case, the communications link may comprise any combination of various types of wired and/or wireless links; comprise any combination of one or more types of networks; and/or utilize any combination of various types of transmission techniques and protocols.

Video conferencing program 130 enables computing system 110 to manage some or all of a video conference between a user 120 and a third party 140. To this extent, computing system 110 may configure the display of a first video conference participant, such as user 120, to one or more other video conference participants, such as third party 140. As defined herein, a video conference participant may refer to a user, group of users, area, or any combination thereof within the field of view of a camera used for video conferencing. For example, to describe various aspects of the invention further, user 120 and third party 140 are on a project team working for an entity. Computing system 110 may manage background data 160 corresponding to the area behind the video conferencing presenter (e.g., user 120), which may include an area upon which the presenter may be presenting live information to be utilized in conjunction with the video conferencing of its personnel. The area may correspond to various surfaces utilized for presenting live information such as, a whiteboard, a blackboard, projector screen, wall, region of interest, or any surface suitable to present information. Background data 160 may comprise static image data (e.g., slide of a slideshow), live image data corresponding to live note taking, a live or recorded video (e.g., video from internet), a static or non-static webpage, or the like. Computing system 110 may manage segmentation data 150 corresponding to human-like objects, region of background captured by a camera, or obstructions to background data 160 that correspond to various undesired portions of the video that user (e.g., user 120) or third party 140 may consider an obstruction to the information shared between user 120 and third party 140. Segmentation data 150 may undergo various levels of transparency to be combined or merged with background data 160 to be utilized in conjunction with the video conferencing.

Each area of segmentation may be pre-approved or determined by background data 160 for use during a video conference conducted by personnel of the project team. Computing system 110 may manage a set of rules that enable personnel to be segmented or made transparent when the user is in front of an area of interest or a surface configured to share information (e.g., whiteboard, blackboard, screen, etc.) via video conference. For example, a rule may designate a preferred segmentation area for use in conjunction with a particular user, a particular customer and/or type of customer, an employee/customer combination, one or more attributes of the employee and/or customer, a subject matter of the video conference, and/or the like. The set of segmentation selection rules may comprise a hierarchical order to automatically select an appropriate segmentation arca. Background data 160 may also be pre-approved for use during a video conference conducted by personnel of the project team, for example, by team members or team leader. Computing system 110 may manage a set of rules that enable personnel to define the region of interest (e.g., area at which information may be shared) captured by the field of view of camera in use during video conferencing. In the defined region of interest any information may be recorded and continuously displayed to the third party in conjunction with the segmentation data 150.

Computing system 110 may also request approval of segmentation for use in conducting video conferences based on a determined region of interest in the background. For example, an individual may use computing system 110 to set limits or portions of background that may be a surface, a static image, a set of presentation slides, recorded video, a link to a live video feed, a web page, a web address, etc., where user 120 would like to utilize for sharing information (e.g., region of interest) during a video conference. In this case, background regions corresponding to the region of interest may be stored as a rule to utilize features of segmentation data when an obstruction is present in the background determined via background data 160.

In some examples, segmentation data 150 may be utilized for a limited number of uses (e.g., only during a particular video conference), a limited amount of time (e.g., during the next week), for only certain personnel, or the like. To this extent, the segmentation data 160 may include approval information, which enables computing system 110 to ensure that a segmentation area determined via background data may continue to be used by the user. In an example, all approvals may have a default time period for which they are valid, and after which continued use of the segmentation requires re-approval, e.g., to ensure that current segmentation area determined is still usable based on the background data 160.

When setting up a video conference, a user 120 may provide conferencing data 170, which may comprise various attributes of the video conference and/or the participants of the video conference for processing by computing system 110. For example, the user 120 may provide identification information for the user 120, one or more third parties 140, a subject matter of the video conference, a time/date for the video conference, etc., using any solution (e.g., a graphical user interface presented by computing system 110). In an example, the user 120 may enter some or all of the conferencing data 170 in a calendaring system, and computing system 110 may obtain the information from a calendar invitation for the video conference. Computing system 110 also may obtain additional identification information regarding a third party 140, which computing system 110 may utilize to select a segmentation area for the video conference. For example, computing system 110 may access a customer profile corresponding to the identified third party 140, user 120 may provide additional identification information, or the like. The additional identification information may include, for example, a geographic location, current/new customer, internet protocol (IP)/Mac address information, the participant's name/position, the corresponding business entity's name, etc.

Computing system 110 may provide the segmentation area for review by the user 120 before it is utilized during the video conference. In this manner, the user 120 is aware of the area within the background that will experience segmentation or areas where presenter will be transparent or semi-transparent during the video conference and will have an opportunity to prevent an undesired segmentation area from being used.

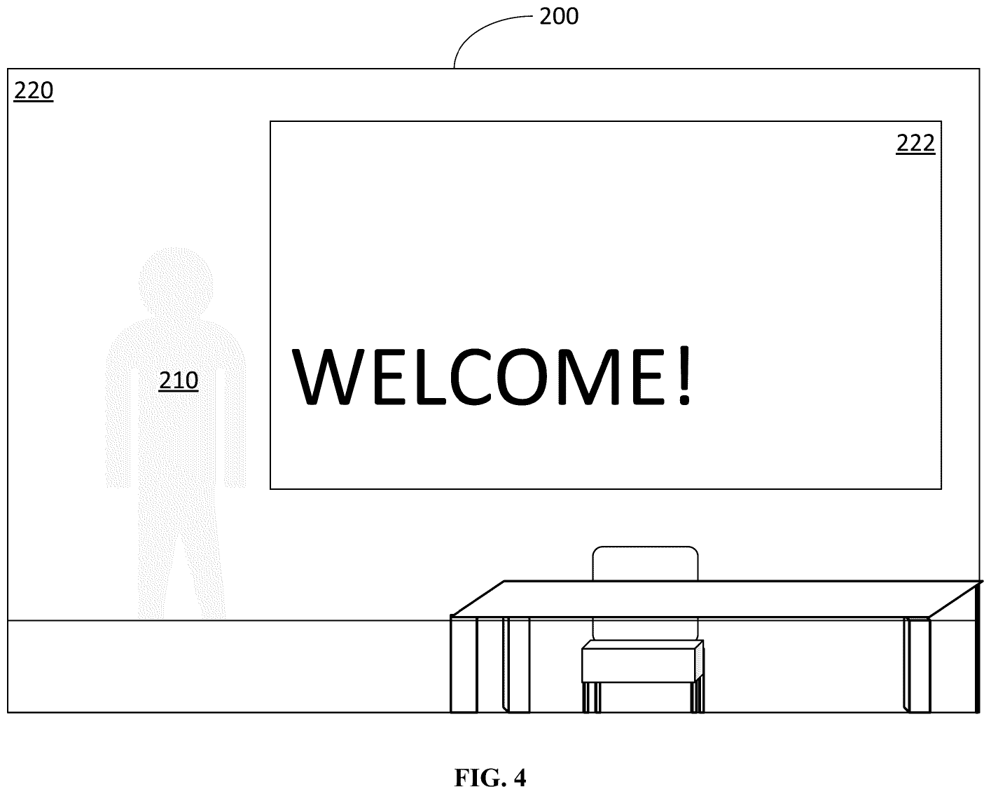

During the video conference, a video of an individual (e.g., presenter) is recorded via a user system 120. FIG. 4 illustrates image data 200 captured by a camera for a presenter of a video conference. Image data 200 includes presenter data 210 corresponding to the user 120 (may also be segmentation data 150) as well as background image data 220 corresponding to the background located behind the user 120. In this case, background image data 220 shows a surface 222 containing written text. To this extent, the surface 222 may be obstructed to third parties 140 during the video conference. User 120 may not want third parties 140 or project team members to have an adverse team experience and miss out on shared information disrupting a collaborative environment based on the positioning of presenter or user 120.

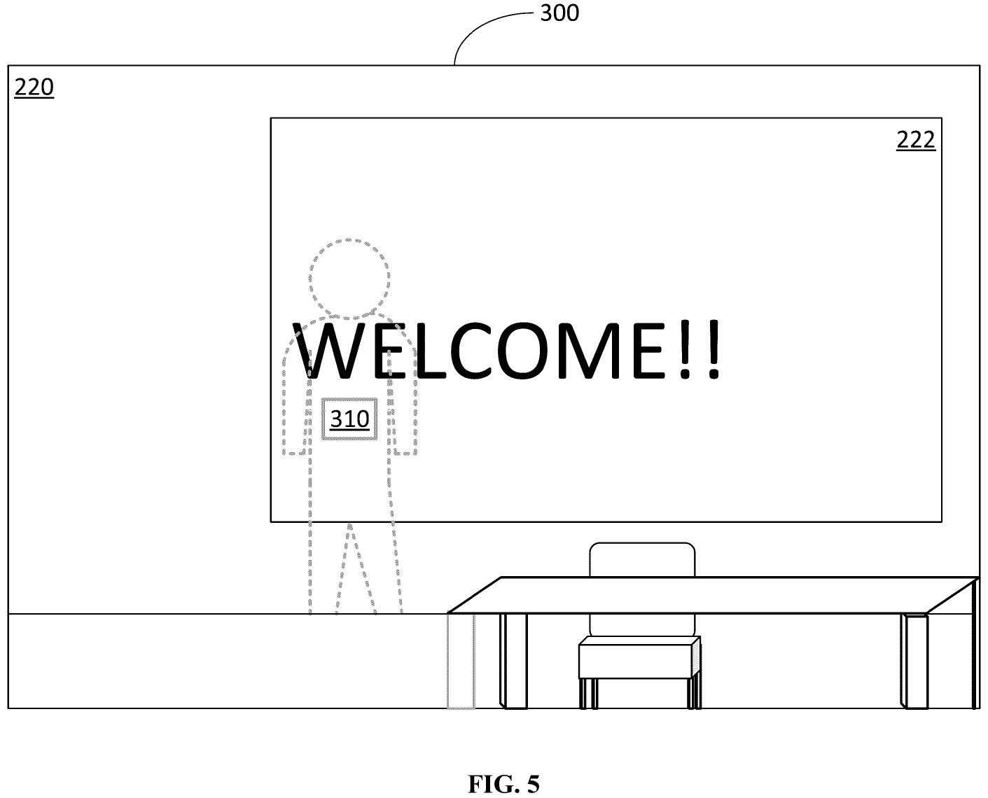

Image data 200 may be processed to isolate the presenter data 210 (e.g., segmentation data 150) from the background image data 220. In an example, the user system 120 may include software configured to identify, isolate, or manage transparency of presenter data 210 (e.g., segmentation data 150) in a video stream from the background data 220. In an alternative example, the user system 120 may provide video data including all of the image data 200 for processing by the computing system 110, which in turn isolates the presenter data 210 from the background data 220. Subsequently, the isolated presenter video data may be made transparent and merged with the background (e.g., background data 160) for presentation to a third party 140. As described herein, any of various computing devices, such as user system 120, computing system 110, third party system 140, or any combination thereof, may merge the isolated presenter video data (e.g., segmentation data 150) with the background (e.g., background data 160) during the video conference. The background image data 220 may present or communicate desired information that the user 120 wants to project to third parties 140. For example, FIG. 5 shows illustrative presented image data 300 including isolated presenter image data 310 and background data 220 according to an example. In this case, the presenter image data 310 is located in front of surface 222 determined via background data 160. Captured presenter data 310 may be altered to appear transparent to third parties 140 to allow for sharing of information on surface 222 to be seen.

In the example illustrated by FIGS. 4 and 5, the merging includes substitution of the captured presenter image data 310 (segmentation data 150) with the background image data 220 (e.g., background data 160) without adjusting any attributes of the background image data 220. In this case, the location, relative size, etc., of the surface 222 remains the same for the captured image data 200 and the presented image data 300. In an alternative example, the merging may include adjusting one or more aspects of the surface 222 or background data 220. For example, one or more of the size, location, or the like, of background data 220 may be altered to locate information in a region of interest of the background (e.g., surface 222). The adjustment may be performed, for example, in order to locate information on surface 222 in an area of background data 220 that is relevant to the desired information being shared on surface 222. In an example, computing system 110 may manage background data 160, which identifies a region of interest to undergo segmentation (i.e., captured presenter image data 310) or become transparent over background 220. Transparency of captured presenter image data 310 is denoted by dotted line as shown in FIG. 5. In this case, the merging may include relocating or adjusting the size of the surface 222 so that it remains within the identified or defined region of interest.

It is understood that while the use of a single surface during a video conference has been described herein, multiple surfaces may be utilized during a video conference. In particular, a surface used for a user 120 may be alternated between a plurality of surfaces within the view of the camera during the video conference.

As described herein, aspects of the invention enable the management of presenter image data to selectively project a non-obstructed image or other content relevant to a user to other participants of a video conference. Additionally, it is understood that aspects of the invention may enable the management and level of transparency of presenter image data to seamlessly project and share information or content to a third party 140 from users 120 of a video conference.

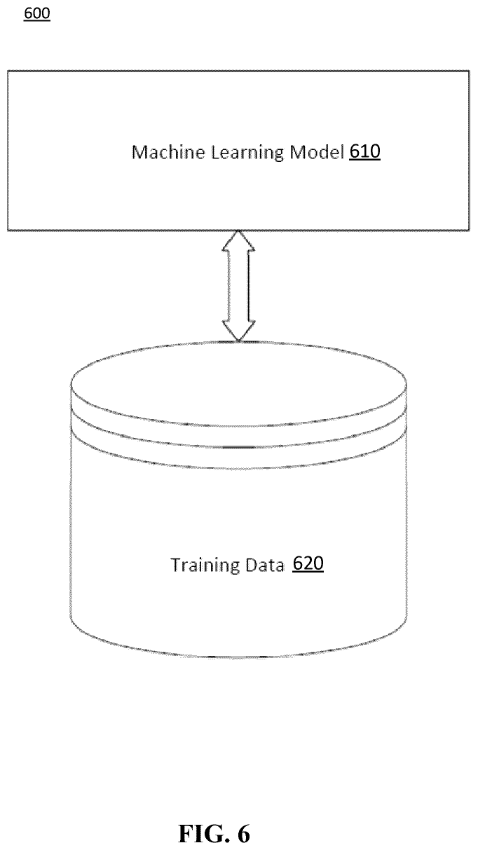

FIG. 6 illustrates a framework 600 employed by a software application (e.g., algorithm) for facilitating determination of segmentation in some examples. The framework 600 may be hosted remotely. Alternatively, the framework 600 may reside within the UE 30 shown in FIG. 2 or be processed by the computing system 110 shown in FIG. 3. The machine learning model 610 is operably coupled to the stored training data 620 in a database.

In an example, the training data 620 may include attributes of thousands of objects. For example, the objects may be a smart device (e.g., communication device 11, 12, 13, 14 or UE 30), computer (computing system 110), person (e.g., user 120), book, newspaper, sign, car, content items (e.g., messages, notifications, images, videos, audio), and the like. Attributes may include but are not limited to the size, shape, orientation, position of the object, etc. The training data 620 employed by the machine learning model 610 maybe fixed or updated periodically. Alternatively, the training data 620 may be updated in real-time based upon the evaluations performed by the machine learning model 610 in a non-training mode. This is illustrated by the double-sided arrow connecting the machine learning model 610 and stored training data 620.

In operation, the machine learning model 610 may evaluate attributes of images/videos obtained by hardware (e.g., of computing device 110, UE 30, etc.). For example, the camera 54 of the UE shown in FIG. 2 senses and captures an image/video, such as for example, user (e.g., user 120) bodily positions, background information (e.g., background data 160), or other objects, appearing in or around a bounding box of a software application. The attributes of the captured image (e.g., segmentation data 150) are then compared with respective attributes of stored training data 620 (e.g., prestored human-like shapes, objects, etc.). The likelihood of similarity between each of the obtained attributes (e.g., of the captured image of a presenter and background) and the stored training data 820 (e.g., prestored human-like objects) is given a confidence score. In one example, if the confidence score exceeds a predetermined threshold, the machine learning module may communicate with the computing device 110 to enable or process transparency for segmentation. In another example, the description may include a certain number of attributes which exceed a predetermined threshold to determine when or whether to present segmentation data as transparent to third parties 140 as shown in FIG. 3. The sensitivity of sharing more or less attributes of presenter image data 210 may be customized based upon the needs of the particular user.

The foregoing description of the examples has been presented for the purpose of illustration; it is not intended to be exhaustive or to limit the patent rights to the precise forms disclosed. Persons skilled in the relevant art may appreciate that many modifications and variations are possible in light of the above disclosure.

Some portions of this description describe the examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one example, a software module is implemented with a computer program product comprising a computer-readable medium containing computer program code, which may be executed by a computer processor for performing any or all of the steps, operations, or processes described.

Examples also may relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples also may relate to a product that is produced by a computing process described herein. Such a product may comprise information resulting from a computing process, where the information is stored on a non-transitory, tangible computer readable storage medium and may include any example of a computer program product or other data combination described herein.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the examples is intended to be illustrative, but not limiting, of the scope of the patent rights, which is set forth in the following claims.

What is claimed:

1. A method comprising:
configuring display of a first participant to a second participant of a video conference using a computer system, the configuring including:
selecting an area for segmentation for the first participant based on a position of the first participant;
applying a segmentation in response to the position of the first participant using the computer system, wherein the first participant is presenting information to a second participant; and
providing a background from the computer system for display to the second participant in conjunction with isolated segmentation data corresponding to the position of the first participant isolated from the background of the first participant during the video conference.

2. The method of claim 1, wherein the area for segmentation is selected from a group comprising: region of interest, shape of the region of interest, human-like properties, or obstruction of background data.

3. The method of claim 2, wherein the second participant is not sharing an environment with the first participant.

4. The method of claim 1, further comprising enabling the segmentation corresponding to the first participant becoming transparent to the background from the computer system for display to the second participant in conjunction with the background during the video conference.

5. The method of claim 4, wherein the providing the background and providing isolated segmentation data, associated with the segmentation, are performed during the video conference, the method further comprising merging the background and the isolated segmented data on the computer system.

6. The method of claim 1, further comprising providing a merged image of the isolated segmented data and the background for display to the second participant during the video conference.

7. The method of claim 1, wherein displaying the background to the second participant occurs simultaneously as the area for segmentation changes positions relative to the background.

8. The method of claim 1, wherein the computer system effectuates code to make the area for segmentation, associated with the first participant transparent, to allow the second participant to view the background associated with the computer system of the first participant.

9. The method of claim 2, wherein the region of interest may be any surface containing information to be shared from the first participant to the second participant associated with the background.
